(19) United States
(12) Patent Application Publication
(10) Pub. No.: US 2014/0006079 A1
(43) Pub. Date: Jan. 2, 2014

(54) SCHEDULING VIEWING OF RECORDED EVENTS

(71) Applicants: Susann M. Keohane, Austin, TX (US); Shawn P. Mullen, Buda, TX (US); Jessica C. Murillo, Round Rock, TX (US); Johnny M. Shieh, Austin, TX (US)

(72) Inventors: Susann M. Keohane, Austin, TX (US); Shawn P. Mullen, Buda, TX (US); Jessica C. Murillo, Round Rock, TX (US); Johnny M. Shieh, Austin, TX (US)

(73) Assignee: INTERNATIONAL BUSINESS MACHINES CORPORATION, Armonk, NY (US)

(21) Appl. No.: 13/536,775

(22) Filed: Jun. 28, 2012

(51) Int. Cl. G06Q 10/10

(52) U.S. Cl. 705/7.19

(57) ABSTRACT

Methods, systems, and computer program products may schedule viewing of a recorded event. The method may include receiving, by an electronic apparatus, an electronic request for an invitee to attend an event that will be recorded, and determining, by the electronic apparatus, that the invitee cannot attend the event. The method may additionally include determining, by the electronic apparatus, one or more open time intervals on an electronic calendar of the invitee to view a recording of the event, and selecting, by the electronic apparatus, at least one open time interval from the determined one or more open time intervals. The method may further include scheduling, by the electronic apparatus, viewing of the recording during the selected open time interval on the electronic calendar.

### BACKGROUND

The present inventions relate to electronic scheduling systems, and in particular, to systems that schedule viewing of recorded events.

Meetings, conferences, presentations, and similar events may include live content, such as a speech or a forum discussion, and/or prepared content, such as an electronic slideshow or an audio-video presentation. The content may be broadcasted and/or otherwise transmitted, which may enable remote attendance to the event. The content also may be recorded, which may enable time-shifted attendance via viewing of a copy of the recording. An invitation to an event may include data about the event, such as data to identify the date, time, and/or subject of the event, so that an invitee can determine whether he or she wants to attend the event and/or view a recording of the event.

### BRIEF SUMMARY

According to one embodiment, a method may include receiving, by an electronic apparatus, an electronic request for an invitee to attend an event that will be recorded, and determining, by the electronic apparatus, that the invitee cannot attend the event. The method may additionally include determining, by the electronic apparatus, one or more open time intervals on an electronic calendar of the invitee to view a recording of the event, and selecting, by the electronic apparatus, at least one open time interval from the determined one or more open time intervals. The method may further include scheduling, by the electronic apparatus, viewing of the recording during the selected open time interval on the electronic calendar.

According to one embodiment, a computer system may include a processor and a memory. The computer system may additionally include a program comprising a plurality of instructions stored in the memory that are executed by the processor to receive an electronic request for an invitee to attend an event that will be recorded, and determine that the invitee cannot attend the event. The plurality of instructions additionally comprises instructions that are executed by the processor to determine one or more open time intervals on an electronic calendar of the invitee to view a recording of the event, and select at least one open time interval from the determined one or more open time intervals. The plurality of instructions further comprises instructions that are executed by the processor to schedule viewing of the recording during the selected open time interval on the electronic calendar.

According to one embodiment, a computer program product for scheduling viewing of a recorded event may include at least one computer readable storage medium having computer readable program instructions embodied therewith. The computer readable program instructions, when read by a processor, may be configured to receive an electronic request for an invitee to attend an event that will be recorded, and determine that the invitee cannot attend the event. The computer readable program instructions, when read by a processor, may be additionally configured to determine one or more open time intervals on an electronic calendar of the invitee to view a recording of the event, and select at least one open time interval from the determined one or more open time intervals. The computer readable program instructions, when read by a processor, may be further configured to schedule viewing of the recording during the selected open time interval on the electronic calendar.

Any of the above embodiments may be embodied as computer-based methods, systems, or program products.

### BRIEF DESCRIPTION OF THE SEVERAL VIEWS OF THE DRAWINGS

FIG. 1 is a pictorial representation of an example of a computer system in which illustrative embodiments may be implemented.

FIG. 2 is a block diagram of an example of a computer in which illustrative embodiments may be implemented.

FIG. 3 is a block diagram of an example of an electronic scheduling system in accordance with the principles of the present inventions.

FIG. 4 is a block diagram of examples of scheduling parameters of an electronic request in accordance with the principles of the present inventions.

FIG. 5 is a block diagram of an example of an electronic calendar in accordance with the principles of the present inventions.

FIG. 6 is a block diagram of an example of time-span analysis and appointment-conflict analysis in accordance with the principles of the present inventions.

FIG. 7 is a block diagram of an example of determining the predicted length of a planned event in accordance with the principles of the present inventions.

FIG. 8 is a block diagram of an example of determining the actual length of a recorded event in accordance with the principles of the present inventions.

FIG. 9. is a block diagram of dividing a recorded event into a plurality of segments distributed to a series of time intervals in accordance with the principles of the present inventions.

FIG. 10 is a block diagram of selecting time intervals for viewing an event before its expiration date in accordance with the principles of the present inventions.

FIG. 11 is a block diagram of resuming viewing of an event after partial viewing of the event in accordance with the principles of the present inventions.

FIG. 12 is a block diagram of an example of a method of scheduling viewing of a recorded event in accordance with the principles of the present inventions.

### DETAILED DESCRIPTION

As will be appreciated by one skilled in the art, aspects of the present inventions may be embodied as a system, method, or computer program product. Accordingly, aspects of the present inventions may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present inventions may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventions may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventions are described below with reference to flowchart illustrations and/or block diagrams of methods, apparatus (systems) and computer program products according to embodiments of the inventions. It will be understood that each block of the flowchart illustrations and/or block diagrams, and combinations of blocks in the flowchart illustrations and/or block diagrams, can be implemented by computer program instructions. These computer program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart and/or block diagram block or blocks.

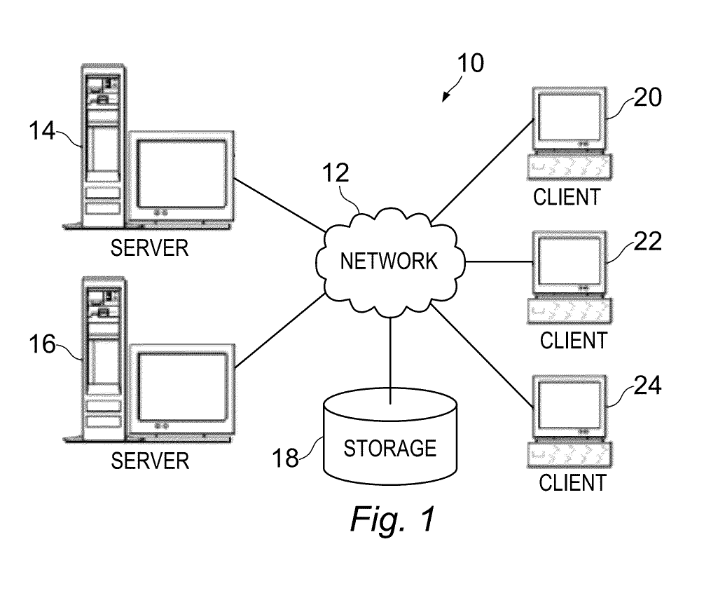

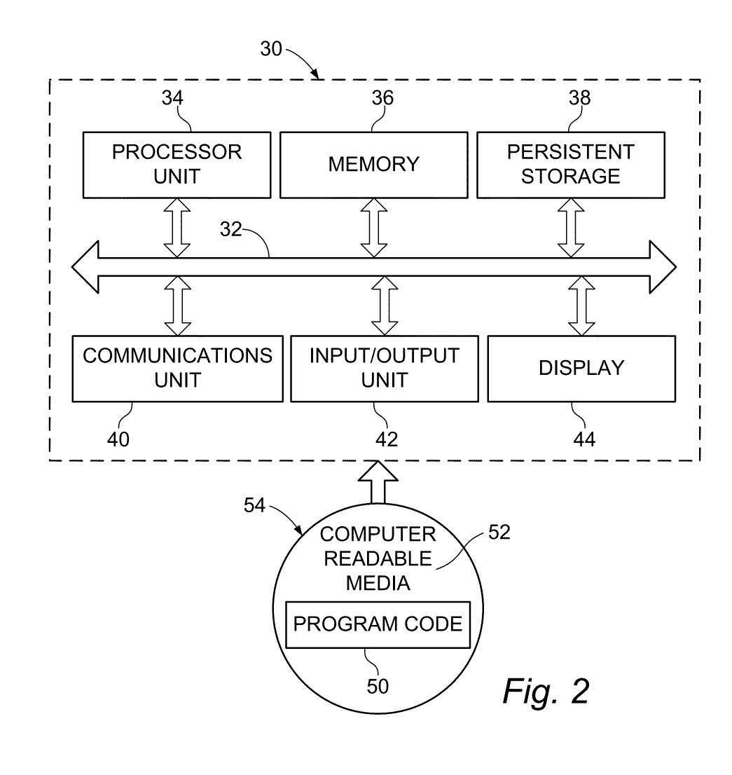

With reference now to the figures and in particular to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

The flowcharts and block diagrams in the figures illustrate the architecture, functionality, and operation of possible implementations of systems, methods and computer program products according to various embodiments of the present inventions. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

FIG. 1 depicts a computer system, indicated generally at 10, and including a network of computers in which illustrative embodiments may be implemented. Computer system 10 may contain a network 12, which is the medium used to provide communications links between various devices and computers connected together within computer system 10. Network 12 may include connections, such as wire, wireless communication links, or fiber optic cables, or combinations of such connections.

In the depicted example, a server 14 and a server 16 may connect to network 12 along with a storage unit 18. In addition, one or more client computers may connect to network 12, such as a first client computer 20, a second client computer 22, and a third client computer 24. Client computers 20, 22, and 24 may be, for example, personal computers work stations, or network computers. In the depicted example, server 14 may provide data, such as boot files, operating system images, and/or software applications to client computers 20, 22, and 24. Client computers 20, 22, and 24 are clients to server 14 in this example. Computer system 10 may include additional servers, clients, and other devices not shown, or may include fewer devices than those shown.

In the depicted example, network 12 may be or may include the Internet. Computer system 10 also may be implemented with a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of an exemplary data processing system 30 is shown in which illustrative embodiments may be implemented. Data processing system 30 is an example of a computer, such as server 14 or client computer 20 in FIG. 1, in which computer-usable program code or instructions implementing the processes may be located for the illustrative embodiments. In this illustrative example, data processing system 30 may include communications fabric 32, which provides communications between a processor unit 34, a memory 36, a persistent storage 38, a communications unit 40, an input/output (I/O) unit 42, and a display 44. In other examples, a data processing system may include more or fewer devices.

Processor unit 34, also referred to simply as a processor, may serve to execute instructions for software that may be loaded into memory 36 from persistent storage 38. Processor unit 34 may be a set of one or more processors or may be a multi-processor core, depending on the particular implementation. Further, processor unit 34 may be implemented using one or more heterogeneous processor systems in which a main processor is present with secondary processors on a single chip. As another illustrative example, processor unit 34 may be a symmetric multi-processor system containing multiple processors of the same type.

Memory 36 and persistent storage 38 are examples of storage devices. A storage device is any piece of hardware that is capable of storing information either on a temporary basis and/or a permanent basis. Memory 36, in these examples, may be, for example, a random access memory or any other suitable volatile or non-volatile storage device. Persistent storage 38 may take various forms depending on the particular implementation. For example, persistent storage 38 may contain one or more components or devices. For example, persistent storage 38 may be a hard drive, a flash memory, a rewritable optical disk, a rewritable magnetic tape, or some combination of the above. The media used by persistent storage 38 also may be removable. For example, a removable hard drive may be used for persistent storage 38.

Communications unit 40, in these examples, provides for communications with other data processing systems or devices. For example, communications unit 40 may be a network interface card. Communications unit 40 may provide communications through the use of either or both physical and wireless communications links.

Input/output unit 42 allows for input and output of data with other devices that may be connected to data processing system 30. For example, input/output unit 42 may provide a connection for user input through a keyboard and mouse. Further, input/output unit 42 may send output to a printer. Display 44 displays information to a user.

Instructions for the operating system and applications or programs are located on persistent storage 38. These instructions may be loaded into memory 36 for execution by processor unit 34. The processes of the different embodiments may be performed by processor unit 34 using computer implemented instructions, which may be located in a memory, such as memory 36. These instructions are referred to as program code, computer-usable program code, or computer-readable program code that may be read and executed by a processor in processor unit 34. The program code in the different embodiments may be embodied on different physical or tangible computer-readable media, such as memory 36 or persistent storage 38.

Program code 50 may be located in a functional form on a computer-readable media 52 that is resident on a local or remote storage device or is selectively removable and may be loaded onto or transferred to data processing system 30 for execution by processor unit 34. Program code 50 and computer-readable media 52 form computer program product 54 in these examples. In one example, computer-readable media 52 may be in a tangible form, such as, for example, an optical or magnetic disc that is inserted or placed into a drive or other device that is part of persistent storage 38 for transfer onto a storage device, such as a hard drive that is part of persistent storage 38. In a tangible form, computer-readable media 52 also may take the form of a persistent storage, such as a hard drive, a thumb drive, or a flash memory that is connected to data processing system 30. The tangible form of computer-readable media 52 is also referred to as computer-recordable storage media. In some instances, computer-recordable media 52 may not be removable.

Alternatively, program code 50 may be transferred to data processing system 30 from computer-readable media 52 through a communications link to communications unit 40 and/or through a connection to input/output unit 42. The communications link and/or the connection may be physical or wireless, or a combination of physical and wireless in the illustrative examples. The computer-readable media also may take the form of non-tangible media, such as communications links or wireless transmissions containing the program code. The different components illustrated for data processing system 30 are not meant to provide architectural limitations to the manner in which different embodiments may be implemented. The different illustrative embodiments may be implemented in a data processing system including components in addition to or in place of those illustrated for data processing system 30. Other components shown in FIG. 2 can be varied from the illustrative examples shown. As one example, a storage device in data processing system 30 is any hardware apparatus that may store data. Memory 36, persistent storage 38, and computer-readable media 52 are examples of storage devices in tangible forms.

In another example, a bus system may be used to implement communications fabric 32 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 36 or a cache such as found in an interface and memory controller hub that maybe present in communications fabric 32.

As noted above, systems, methods, and computer program products are disclosed herein for scheduling invitations to events including recorded events.

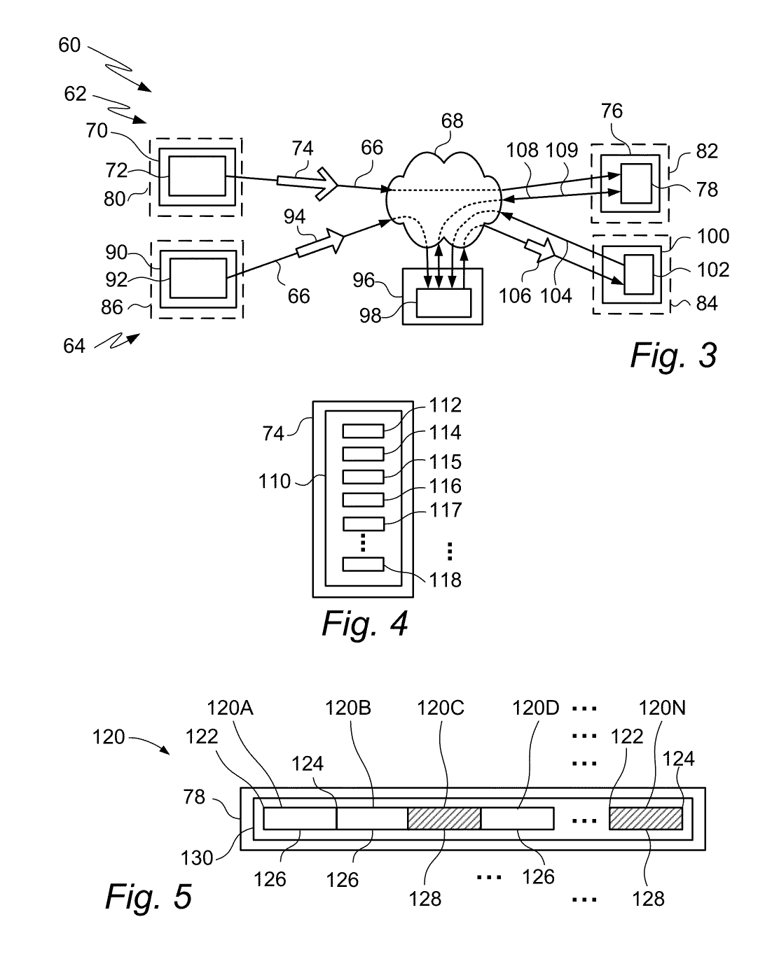

Referring now also to FIG. 3, an electronic scheduling system, indicated generally at 60 and also referred to as system 60, may comprise an invitation subsystem 62 and an event subsystem 64. System 60 may be an example of computer system 10 of FIG. 1. System 60, invitation subsystem 62, and/or event subsystem 64 may include other alternative and/or additional elements and/or may omit one or more of the elements described for each herein.

Invitation subsystem 62 may send, transmit, receive, and process an electronic request 74, such as an electronic invitation or announcement. Invitation subsystem 62 accordingly may comprise at least one requesting device 70 running an invitation tool 72, at least one electronic request 74, at least one network 66, and at least one electronic apparatus 76 running an electronic calendar 78.

A requesting device 70 may be a networked computer or other device used to transmit electronic request 74 generated by, for example, invitation tool 72 running on requesting device 70. Examples of requesting devices 70 may include personal computers, desktop computers, laptop computers, personal digital assistants, tablet devices, touch-screen devices, touch-pad devices, smart phones, cellular telephones, etc. Device 70 may be an example of client 20, 22, 24 or a server 14, 16. Device 70 may be a remote device accessed indirectly (e.g., through website used to prepare and send messages, such as electronic requests 74). A person, business, organization, or group associated with device 70 and uses the device to send requests 74 may be referred to as an inviter 80.

Invitation tool 72 may be an application, utility, program, or service used to prepare, generate, and/or transmit electronic request 74. The invitation tool may provide features that receive user input to specify the date, start time, end time, title, location, invitees, and/or other attributes of an event, such as a meeting. Invitation tool 72 may provide features that generate a corresponding request 74 (such as an announcement or invitation) and transmit the request to the specified invitees.

An example of invitation tool 72 may be an email program that offers a special-purpose message format that functions as an announcement or invitation; that allows each recipient (or invitee) to accept or decline the invitation; and/or that integrates with calendar and reminder systems. For example, the email program may provide features that allow the user (or inviter 80) to define the attributes of the event and to list the email addresses of the invitees. The email program may also provide features that generate the resulting invitation message (such as electronic request 74) and transmit the message to the list of one or more invitees.

Other examples of invitation tool 72 may include applications or services used to prepare and send requests 74 in the form of text messages, instant messages, pager messages, RSS feeds, announcements on social-media websites, etc. Invitation tool 72 may be configured to allow inviter 80 to prepare and send requests 74 and/or configured to function as an automated or robotic device.

Network 66 may be a computer network that provides communications services for invitation subsystem 62 and/or event subsystem 64. For example, requesting device 70 connected to network 66 may send electronic request 74 to electronic apparatus 76 also connected to network 66. Network 66 may be hardwired and/or wireless and may include the Internet and/or a cloud 68. Network 66 may be an example of network 12 of FIG. 1.

Electronic request 74 is a message sent from requesting device 70 to one or more electronic apparatuses 76. Request 74 may function as, for example, an announcement of or invitation to a particular event, such as presentation or a meeting.

Referring now also to FIG. 4, request 74 may include scheduling parameters 110 that detail the event. For example, scheduling parameters 110 may include an event date 112, an event start time 114, an event end time 115, a title 116, location 117, an event length 118, and/or other values. Event start time 114 and event end time 115 may include both date and time data, such as to allow for events that start on one day and end on another day. Event length 118 may be a parameter (a stored value) and/or a calculated value (e.g., computed from times 114 and 115). One or more values of scheduling parameters 110, such as event date 112, start time 114, and end time 115, may be adjusted to compensate for time-zone differences. For example, one or more of those values may be expressed in a specified time zone, such as GMT. Parameters 110 of FIG. 4 are representative examples. Request 74 may omit any or all these parameters and/or include parameters not mentioned here.

Request 74 may include content, markup, and/or metadata to expedite automated parsing of request 74. For example, parameters 110 may be designated by a distinctive heading that may be visible to a human reader (such as invitee 82) and detectable by parsing (e.g., by rules, string functions, and other programmatic techniques). For example, an HTML- or XML-format message may include distinctive markup (such as <div> or <span> blocks) that include identifiers and simplify automated parsing. In short, request 74 may be generated in a format that is convenient to human readers and/or convenient for automated processing by, for example, electronic apparatus 76 that receives request 74.

Request 74 may be prepared as an invitation to a planned event or as an announcement of a past event, such as to publicize the availability of a recorded event 98. For a request that functions as an invitation, event start time 114, event end time 115, and other values may be regarded as predicted values. For a request that functions as an announcement, the values may be actual and/or known values. In an embodiment, request 74 may include data that indicates whether the request is (or was) an invitation to a future event or an announcement of a present or past event such that calendar 78 can properly interpret the data in the request.

Electronic apparatus 76 may be a networked computer or other device used to receive electronic request 74 by, for example, running electronic calendar 78. Examples of apparatus 76 may include personal computers, desktop computers, laptop computers, personal digital assistants, tablet devices, touch-screen devices, touch-pad devices, smart phones, cellular telephones, etc. Apparatus 76 may be a client 20, 22, 24 or a server 14, 16. A person, business, organization, and/or other group associated with apparatus 76, such as to use the device to receive requests 74, may be referred to as invitee 82. The user of the electronic apparatus may be the invitee named in the electronic request or may be a different person from the invitee, such as when the user is assisting the invitee in managing the invitee's schedule and/or calendar.

Referring also now to FIG. 5, electronic calendar 78 may be an application, program, utility, or service (or a portion thereof) that provides a computerized method of organizing time. Calendar 78 may, for example, display a software version of a days-weeks-months calendar and provide an appointment feature that helps the user of calendar 78 keep track of time commitments, such as business meetings and social engagements. Electronic calendar 78 may divide time into a set or series of time intervals 120A-N, each with an associated interval date, an interval start time 122, an interval end time 124, and/or other associated values and/or data. Intervals 120 may be defined or selected as a series of adjacent, abutting portions of time, so that each instant in time maps into one interval of the series of intervals. Calendar 78 may maintain a registry 130 to keep track of data associated with time intervals 120. This data may include an indication of whether each interval 120 is open or occupied. An open interval 126 may be one without an associated appointment (or uncommitted time). An occupied interval 130 may be one with an associated appointment spanning all or part of the interval (or time assigned to or designated for some purpose, such as attending an event). Calendar 78 may register or record additional data such as, for each occupied interval, a description of the associated appointment. The unit of measure for intervals may be any convenient quantity, such as minutes or hours. Intervals may differ in duration.

For example, FIG. 5 shows a representation of a calendar 78 that includes a series of time intervals 120A-N and registry 130. When invitee 82 or user of calendar 78 accepts an appointment, such as an electronic event 94, calendar 78 may designate the corresponding time interval(s) 120 as occupied and unavailable. In the example, the invitee or user has not accepted an appointment during interval 120A. Calendar 78 accordingly indicates that interval 120A is an open interval 126 and available for a new appointment. The adjacent interval 120B is also open for a new appointment, which may potentially span the combined intervals 120A and 120B. As it happens, the invitee or user has accepted an appointment during interval 120C, which is registered and indicated as an occupied interval 128 and unavailable for conflicting use. If the invitee or user attempts to accept another appointment that overlaps with occupied interval 128, then calendar 78 may warn the user of the conflict and/or block the attempt to accept a conflicting appointment.

As detailed elsewhere, calendar 78 may provide other features, such as the ability to parse an electronic request 74 to detect a conflict between electronic event 94 of request 74 and concurrent time interval(s) 120; the ability to identify a later open interval 126 long enough to accommodate recorded event 98; etc. Calendar 78 also may provide associated user-interface features, such as the ability to warn the user of conflicts; to suggest one or more alternative open time intervals 126 that can accommodate event 98; etc.

Referring back to FIG. 3, event subsystem 64 may record, transmit, store, and retransmit an electronic event 94. Event subsystem 64 accordingly may comprise an event device 90, network 66, a display device 100, and display software 102. Event subsystem 64 may further comprise recorded event 98, a recording server 96, a playback request 104, and/or a time-shifted event 106.

Electronic event 94 may be an electronic representation of an actual event conducted in a physical and/or virtual space. Examples of actual events may include meetings, conferences, teleconferences, videoconferences, seminars, webinars, slideshows, electronic slideshows, trade-shows, employee forums, training sessions, online games, distance learning, etc. An actual event may be a scheduled event that occurs on a specified date during a specified time interval, which may be defined by a start time and an end time. A physical event may occur at one or more specified locations. An actual event may be converted to electronic event 94, such as to allow distant attendees to view the event in real time and/or to record the event for later use. For example, a live meeting (or an actual event) may be converted to audio-video form (or electronic event 94) by means of a video camera. Electronic event 94 may then be broadcast, streamed, and/or otherwise transmitted to remote attendees. To preserve electronic event 94 for later use, event 94 may be saved, captured, recorded, and/or otherwise stored (such as to a file). For example, an audio-video stream may be converted to an audio-video file and stored in a networked location, such as recording server 96, for playback on request.

Event device 90 may be a networked computer or other device used to acquire and/or transmit an electronic event 94. Examples of event devices 90 include personal computers, desktop computers, laptop computers, personal digital assistants, tablet devices, touch-screen devices, touch-pad devices, smart phones, cellular telephones, etc. Further examples include audio-video equipment, such as still cameras, video cameras, microphones, etc. For example, event device 90 may be a networked computer used to present a lecture by displaying an electronic slideshow, recording the associated spoken narration, and transmitting the lecture over network 66. For example, event device 90 may be a digital motion picture camera connected to network 66 and streaming sound and picture from a live meeting to remote attendees. Many kinds of devices may be used in the context of an actual event to present slideshows, acquire audio-visual data, etc. Event device 90 accordingly may encompass one or more of various systems and/or devices involved in converting an actual event to a transmittable format as electronic event 94. A person, business, organization, or group associated with event device 90 that uses the device to transmit electronic event 94, may be referred to as a presenter 86.

Event device 90 and requesting device 70 may be the same physical device. For example, inviter 80 and presenter 86 may be the same person sending electronic requests 74 from a laptop computer and subsequently presenting electronic event 94 from the same laptop computer. General-purpose networked computers may act in different roles at the same time and/or at different times. Thus, the distinction between requesting device 70 and event device 90 may be logical and not physical.

Event software 92 may be any software running on event device 90 to aid in acquiring, generating, and/or transmitting electronic event 94. Event software 92 may include presentation software used to generate an electronic slideshow, video editing software used to mix and assemble an audio-video stream, audio-video software used to convert camera data to a file, and/or other software.

Event device 90 may include event software 92 as a separate or explicate item, such as an installed application that runs on a computer. Device 90 may include software 92 as an intrinsic portion of the device. A video camera with a network connection, for example, may function as a dedicated device 90 that does not overtly separate the hardware of device 90 from software 92 of the device.

Network 66 may be a computer network that provides communications services for event subsystem 64 and/or invitation subsystem 62. For example, event device 90 connected to network 66 may transmit electronic event 94 to recording server 96 that also is connected to network 66. Network 66 may be hardwired and/or wireless and may include the Internet and/or cloud 68. Although FIG. 3 shows network 66 for event subsystem 64 separate from network 66 for invitation subsystem 62, the topology of network 66 may differ from the example of FIG. 3. For example, a single local area network (LAN) may be used for both subsystems.

Recorded event 98 may be a persistent version of electronic event 94, such as a recording of the event 94 saved to a computer file. For example, event 94 may take the form of an audio-video presentation broadcast via network 66 from an actual event, such as a live meeting. Event device 90 (such as via event software 92) may save the audio-video data to a file and may place a copy of the file on recording server 96 in a specified and/or accessible location. The file, persisting on server 96, embodies recorded event 98.

In another example, recorded event 98 may be expressed as a set of instructions saved to a file and interpretable by a computer as electronic event 94. For example, recorded event 98 may take the form of one or more web pages, where the HTML markup, associated scripts, and/or associated media files contain instructions that implement electronic event 94. Recorded event 98 may sometimes be referred to as a “recording.”

Recording server 96 may be a networked computer or file system used to store one or more recorded events 98. Recording server 96 may be a resource designated for temporary or archival storage of one or more recorded events 98 to allow time-shifted use each recorded event 98 by providing ongoing access to a persistent copy. Recording server 96 may be an example of server 14, 16 of FIG. 1.

Display device 100 may be a networked computer or other device that is in communication with recording server 96 and/or that is used to display electronic event 94 and/or recorded event 98. Examples of display devices 100 may include personal computers, desktop computers, laptop computers, personal digital assistants, tablet devices, touch-screen devices, touch-pad devices, smart phones, cellular telephones, etc. A Wi-Fi enabled tablet device, for example, may be used as display device 100 to access and play back recorded event 98 at a convenient time and place.

Display device 100 may be an example of client 20, 22, 24 of FIG. 1. A person, business, organization, or group associated with device 100 and that uses the device to display recorded events 98, may be referred to as a viewer 84, who may be the same person or group as invitee 82. “Display” and its forms may include any presentation of an event including audio-video, audio-only, video-only, still image, and/or computer-generated presentations. “View” and its forms may include any display method and does not imply a limitation to visual display. “View” may, for example, include playing or listening to an audio presentation.

Display software 102 may be any application, program, or utility running on display device 100 to aid in accessing and/or displaying electronic event 94 and/or recorded event 98. Display software 102 may include a viewer or player application that converts data and/or instructions from a file that encodes recorded event 98 into a displayable representation of event 98. For example, a viewer may decode MPEG-format data and instructions into a signal displayable as an audio-visual presentation by display device 100.

Display device 100 may include display software 102 as a separate item, such as an application that runs on a computer used as a display device 100 and/or as an intrinsic or embedded portion of the device. A video kiosk with an integral network connection may, for example, function as a dedicated display device with integral display software 102.

Playback request 104 may be a message or signal transmitted to recording server 96, such as to control playback of the recorded event 98. Playback request 104 may include identifying data to select event 98, such a title, an index associated with event 98, path name, and/or other indicia. The playback request may include control data to specify one or more commands issued to recording server 96, such as instructions to “start playback,” “pause playback,” “resume playback,” “fast forward,” “end playback,” etc.

In an embodiment, playback request 104 may be transmitted to server 96 by display device 100. In an embodiment, playback request 104 may be transmitted to server 96 by electronic apparatus 76, such as via electronic calendar 78. Playback request 104 may include data to identify the device that transmitted request 104 and/or data to identify display device 100, for example, so that one device (e.g., electronic apparatus 76) may control playback directed to a different device (e.g., specified display device 100). In an embodiment, apparatus 76 may communicate with display device 100 to pass data stored by calendar 78 to device 100 such that device 100 may generate and transmit request 104 to server 96 that includes the passed data.

Time-shifted event 106 may be recorded event 98 or a portion of event 98 displayed on a specified display device 100 starting at a specified time. Time-shifted event 106 accordingly may be a delayed presentation of electronic event 94 achieved by a subsequent playback of recorded event 98. Playback request 104 may include instructions that control the playback of a time-shifted event 106. For example, the instructions may start, pause, resume, and/or end the display of the time-shifted event.

FIG. 3 shows logical relationships among the devices and servers of invitation scheduling system 60. The physical relationships may at times differ from FIG. 3. For example, a networked computer may at times play more than one role within system 60. Additionally, event device 90 may act as recording server 96, such as by providing networked access to recorded events 98 stored in a file system of event device 90. Moreover, electronic apparatus 76 may act as display device 100, such as when invitee 82 receives email and plays back recorded events on the same computer. Furthermore, any of the devices may include additional hardware and/or software related or unrelated to system 60. For example, recording server 96 may also function as an email server, such as by relaying and storing email traffic.

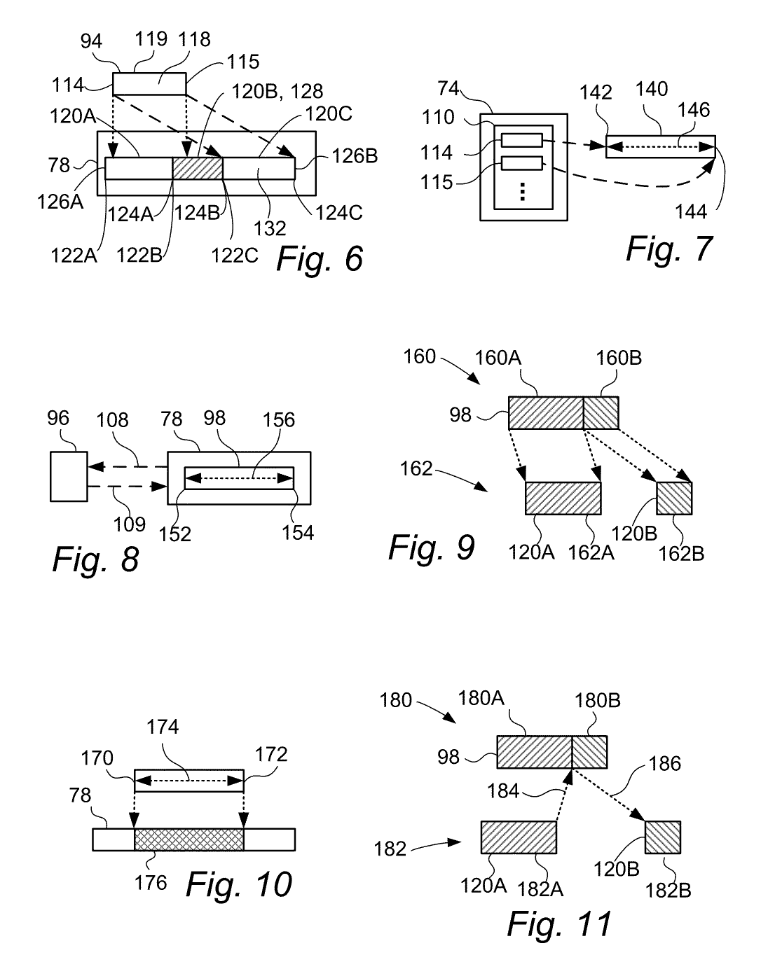

Referring now also to FIG. 6, electronic calendar 78 may determine if invitee 82 can or cannot attend an event in real time, either physically (by attending the actual event) or remotely (by viewing corresponding electronic event 94). For example, on receipt of electronic request 74, calendar 78 may extract, from request 74, one or more scheduling parameters 110, such as event date 112, start time 114, and end time 115. This date/time data defines a time period 119, which is the time span occupied by the event, and which implies an event length 118. Calendar 78 may then compare time period 119 of the event with registry 130 of time intervals 120 maintained by calendar 78 to identify one or more calendar time intervals 120 that overlap with event time period 119. The overlapping intervals represent time intervals 120 that are concurrent with event time period 119. The comparison of concurrent or subsequent intervals 120 with the timing and duration of an event may be referred to as a “time-span analysis.”

If all of the overlapping time intervals are open time intervals 126, then no conflict exists, and invitee 82 can potentially attend the actual event or a corresponding electronic event 94. Calendar 78 may provide a feature or function that allows the user and/or invitee 82 to accept or reject a new appointment for event 94 or to provide input asserting that the invitee cannot attend. On acceptance, calendar 78 may enter event 94 as a new appointment, such as by changing one or more values in registry 130 to indicate that the associated time intervals are occupied intervals, by recording or registering data describing the event, etc. On rejection or other input denying attendance, calendar 78 may continue with further processing. If at least one overlapping time interval 120 is an occupied time interval, then the event conflicts with a pre-existing appointment, and the invitee cannot attend because of the conflict. Calendar 78 may then continue with further processing. For example, the calendar may attempt to identify one or more later, open time intervals suitable for time-shifted viewing of the corresponding event. The analysis of one or more concurrent or subsequent time intervals to detect one or more occupied intervals may be referred to as “appointment-conflict analysis.”

For example, calendar 78 may receive electronic request 74 and extract scheduling parameters 110 that define electronic event 94, such as start time 114 and end time 115 that define time period 119 with a determinable length (or duration) 118. Calendar 78 accordingly maps time period 119 to time intervals 120 and identifies a first concurrent time interval 120, such as by identifying first time interval 120 with start time 122 equal to or less than event start time 114. In the example, interval start time 122A of identified first concurrent time interval 120A is less than (or precedes) event start time 114A, and interval end time 124A precedes event end time 115. The overlapping portion of interval 120A is therefore too brief to accommodate event time period 119. Calendar 78 accordingly identifies the next later adjacent time interval 120 as a second concurrent time interval 120B, compares time interval end time 124B with event end time 115, and determines that end time 124B is greater than (or after) the time period end time 115. In other words, the event 94 ends before the time interval 120B ends. Because event time period 119 starts after first time interval start time 122A and ends before second interval end time 124B, the duration of the combined or spanned time intervals 120A and 120B exceeds duration 118 of time period 119, and calendar 78 may treat the time-span of 120A and 120B as a candidate for entering an appointment for event 94.

Although two time intervals 120A and 120B are sufficient in the example, the time-span analysis may continue to additional concurrent time intervals 120 until the end time of the last of the spanned time intervals is greater than (or after) the end time of time period 119. Although not discussed above, the time-span analysis also may include where the event start time equals the interval start time and/or the event end time equals the interval end time.

Calendar 78 may evaluate each identified concurrent time interval to detect a conflict with a previous appointment. For example, calendar 78 may extract, from registry 130, an indication of the status of each concurrent time interval to identify each concurrent time interval 120 as an open or occupied interval. In the example, first concurrent time interval 120A is an open interval 126A and potentially available for a new appointment for event 94. The second concurrent time interval 120B, in contrast, is an occupied time interval. Because at least one of the two time intervals 120A and 120B is an occupied interval, a conflict exists during time span 120A and 120B, and calendar 78 has determined that invitee 82 cannot attend the event. Calendar 78 may alert the user or invitee 82 of the conflicting appointment and/or block any attempt to enter an appointment that assigns event 94 to time intervals 120A and 120B.

If a user and/or invitee refuses to accept an appointment for event 94, or if the user and/or invitee provides an input that the invitee cannot attend, or if calendar 78 determines that the invitee cannot attend the event 94, then calendar 78 may attempt to identify one or more later, open time intervals suitable for rescheduled viewing of corresponding recorded event 98. The time-span analysis and appointment-conflict analysis for later time intervals may be similar to that of concurrent time intervals, except offset to a later time. A goal is to find one or more later time intervals 120 that provide an open (or uncommitted) block of time during which the invitee may view recorded event 98.

The processing may begin by identifying a first later time interval. Because the calendar time intervals may represent a series of abutting time spans, calendar 78 may identify the first later time interval by selecting the next unevaluated time interval in the series or by obtaining the predicted or actual event end time and seeking the time interval with the next-later start time. Calendar 78 may then compare the interval duration with event length 118. If interval length 132 is greater than or equal to event length 118, then the first later time interval is as long or longer than the event, and calendar 78 may check registry 130 for one or more conflicting appointments. If interval length 132 is less than the event length, then calendar 78 may identify a second later time interval (such as the next one in the series), treat the first and second later intervals together to determine if their combined length equals or exceeds the event duration, and check the registry to rule out conflicting appointments. If appropriate, the process may continue by adding subsequent later time intervals and performing time-span and appointment-conflict analysis on the spanned time intervals. When calendar 78 identifies a block or span of one or more time intervals that pass both the time-span and appointment-conflict checks, then calendar 78 may select the open time intervals as candidates for entering an appointment to view recorded event 98. Calendar 78 may alert the user or invitee of the selection and provide an option to enter an appointment to view the recorded event 98 during the selected later time interval. In an embodiment, calendar 78 may select further open intervals (or blocks of intervals) that are suitable for displaying recorded event 98, such as to allow the user enter an appointment to display recorded event 98 by selecting an item from the list.

For example, calendar 78 may determine that the user cannot attend event 94 in real time because of an appointment conflict during time interval 120B. Calendar 78 accordingly may identify first later time interval 120C and compare event length 118 with interval duration 132. In the example, event length 118 equals interval length 132, so interval 120C passes the time-span analysis. Calendar 78 also determines that interval 120C is an open interval, so interval 120C passes the appointment-conflict analysis. Calendar 78 may provide a feature that offers the user an option to enter an appointment to display recorded event 98 during time interval 120C, such as by offering interval 120C as an item on a list of eligible later time intervals.

When the user enters an appointment to view recorded event 98, calendar 78 may schedule an appointment for recorded event 98 during the designated time interval. Scheduling the appointment may include, for example, changing one or values of registry 130 to indicate that the associated later time intervals are occupied time intervals that are designated and reserved for viewing recorded event 98. Scheduling the appointment may include registering data that identifies the recorded event 98 to be displayed. This data may include title 116 of the recorded event, the URL and/or path of the associated file on the recording server 96, and/or other identifying indicia. Scheduling the appointment may include entering the appointment in a reminder system (which may be a feature of calendar 78) to send reminder messages, such as emails, to the invitee. Scheduling the appointment may include defining mechanisms that trigger the display at the scheduled time by preparing data for communication to display device 100 such that display device 100 and display software 102 can invoke the recording at the appointed start time.

Referring now also to FIG. 7, calendar 78 may determine a predicted length 146 (or duration) of recorded event 98 before the recording is made. Calendar 78 may extract from scheduling parameters 110 one or more values, such as event start time 114 and event end time 115. The values, which may be included in a request 74 transmitted in anticipation of the actual event, may be planned or predicted values. Calendar 78 may use planned start time 142 and planned event end time 144 to calculate a predicted length 146. Calendar 78 may use a predicted start time 142, a predicted end time 144, and predicted length 146 values during time-span analysis, appointment-conflict analysis, and/or other processing. For example, during the interval between the transmission of request 74 and the actual event, calendar 78 may use the predicted values to determine if the invitee cannot attend the event and/or to determine open time intervals to view future recorded event 98.

Referring now also to FIG. 8, calendar 78 may determine an actual length 156 (or duration) of recorded event 98 after the recording is made. For example, calendar 78 may transmit data request 108 to recording server 96 that hosts recorded event 98. Data request 108 may query server 96 for an actual start time 152 and an actual end time 154 of recorded event 98 (and/or for its actual length 156). This data may be available as metadata values embedded in a file that stores the recorded event, as values measured from the recorded event, as values reported by the presenter 86, and/or as values otherwise obtained and stored. Server 96 may return the requested values via data reply 109. Calendar 78 may use actual start time 152 and actual end time 154 of event 98 to calculate its actual length 156 (if not obtained from server 96). Calendar 78 may use the actual time values during time-span analysis, appointment-conflict analysis, and/or other processing. For example, after the recording of the actual event, calendar 78 may use actual values in preference to predicted values to determine if the invitee cannot view the recording the event.

In an embodiment, calendar 78 may compare predicted event start time 142, predicted end time 144, and other values from request 74 to the current time. Request values that are, at the time of the comparison, in the past may trigger data request 108, such as an attempt to obtain updated actual values 152, 154, 156 that may be used in preference to predicted values 142, 144, 146 because actual values are considered more reliable for time-span analysis.

In an embodiment, calendar 78 may divide recorded event 98 into two or more segments 160, select a time interval 120 of calendar 78 separately for each segment, and distribute the series of segments, each a portion of event 98, to a series of time intervals or viewing sessions. For example, invitee 82 with a busy schedule might not have an open and continuous time interval 120 long enough to view an entire recorded event. Thus, the invitee may prefer to watch a recorded event in multiple viewing sessions. Additionally, the invitee may have a desired maximum duration for viewing sessions. To divide recorded event into a series of segments and distribute the segments a series of viewing sessions, calendar 78 may receive request 74 for event 94, obtain or calculate event length 118, 146, or 156 of recorded event 98, compare the event length to a dividing criterion, such as a maximum viewing session length, and (if the event length exceeds the maximum) divided the recorded event into two or more segments, each less than or equal to the maximum viewing session length. Calendar may then determine time interval(s) for each session in the series, and (after user confirmation) enter an appointment for each time interval (i.e., session), preserving the sequence.

Referring now also to FIG. 9, calendar 78 may apply a dividing criterion to divide recorded event 98 into a series of segments, such as a first segment 160A and a second segment 1608. Calendar 78 may then select first segment 160A, apply time-span and appointment-conflict analysis to first segment 160A (or the first portion of event 98), and identify one or more time intervals 120A for a first viewing session 162A of event 98. Calendar 78 may then select second segment 160B, repeat the process, and identify a later time interval 120B for second viewing session 162B. Calendar 78 accordingly may divide recorded event 98 into a series of viewing sessions 162A, 162B arranged in sequence. FIG. 9 shows a division into only two segments 160A, 160B, but an event may be divided in this manner into any number of suitable segments 160.

In an embodiment, calendar 78 may generate or record context data for each session 162. For example, some file formats and/or playback devices may support mechanisms for generating bookmarks or internal links that each identify or locate particular moment inside time-based content. A video playback system, for example, may have a feature that allows it to seek an internal address within the video content, such as to start or restart playback at some moment in the middle of the video. In an embodiment, calendar 78 may generate or record context data, such as an internal bookmark, address, or the like, and may associate the context data with corresponding event segment 160 and/or viewing session 162 (or time interval 120) associated with each event segment. Calendar 78 may subsequently obtain the context data to, for example, use it to control playback. For example, calendar 78 may store the end time of segment 160A and use the stored end time as a start time for segment 1608, in effect resuming the playback where it left off in session 1628.

Recorded event 98 may have an associated availability date and/or expiration date. The availability date may be a specified date and/or time when the recorded event is expected to be or will be uploaded and made available for viewing. The expiration date may be a specified date and/or time after which the event will become unavailable for viewing. In an embodiment, calendar 78 may obtain the availability and/or expiration dates, such as from recording server 96 via a data request 108 and data reply 109, and consider the availability and expiration dates during the process of determining and selecting one or more time intervals 120 for viewing the event, such as by only including time intervals that are on or after the availability date in the time-slot analysis and/or appointment conflict analysis, and/or by discontinuing the process of performing time-slot analysis and/or appointment-conflict analysis for time intervals after the specified expiration date.

Referring now also to FIG. 10, recorded event 98 may have an availability date 170 and an expiration date 172. The availability date may be a projected publication date/time or simply the earliest actual availability. The expiration date may be a projected deletion or purge date/time for the event. Dates 170 and 172 together define an event lifetime 174, which may be the time period during which the record event is expected to remain accessible for viewing. Event lifetime 174, mapped to calendar 78, yields a viewing window 176, which is the portion of the invitee's calendar greater than or equal to date 170 and less than or equal to date 172.

In an embodiment, calendar 78 may limit the process of selecting time intervals for a recorded event to the period within viewing window 176. Calendar 78 accordingly may in effect offer the invitee a selection among one or more open time intervals 120 that occur only during the lifetime of the recorded event (or after the event is published and before it reaches its expiration date and becomes unavailable). In an embodiment, calendar 78 may offer user-interface features and functions related to expiration dates, such as a mechanism to warn the invitee that an event will expire and encourage viewing during the lifetime of the recorded event.

Referring now also to FIG. 11, calendar 78 may detect partial viewing to allow viewer 84 to pause or stop playback during a viewing session. Calendar 78 accordingly may store context data defining the pause-time or stop-time during the playback of the time-shifted event 106 and resume playback in the same session or a different session. Viewer 84 (or invitee 82) may start playback of a recorded event 98 during a first viewing session 182A and discontinue playback at a stop-time 184. The stopped session 182A, mapped to event 98, defines a watched segment 180A and an unwatched segment 1808 of event 98. Calendar 78 may store a record of stop time 184. At the beginning of later viewing session 182B, calendar 78 may obtain stop time 184 and use it to control playback, such as by resuming playback of event 98 at stop time 184, which is the end time of watched segment 180A and the start time of unwatched segment 1808.

In an embodiment, playback may be paused instead of stopped. If the viewer resumes playback during the paused viewing session 182A, then the event may resume during the same session from where it left off. If session 182A expires when paused or during resumed playback, calendar 78 may treat the expiration as a stop-time 184, store the stop time, and restart playback at a later time interval, if one has been already selected. If none has been selected, calendar 78 may identify and schedule one or more new time intervals (viewing sessions) for unwatched segment 180B. The example of FIG. 11 shows only two segments 180A and 180B and two sessions 182A and 182B. However, the playback of a recorded event may be stopped and resumed any number of times, subject to the ongoing availability of the recorded event.

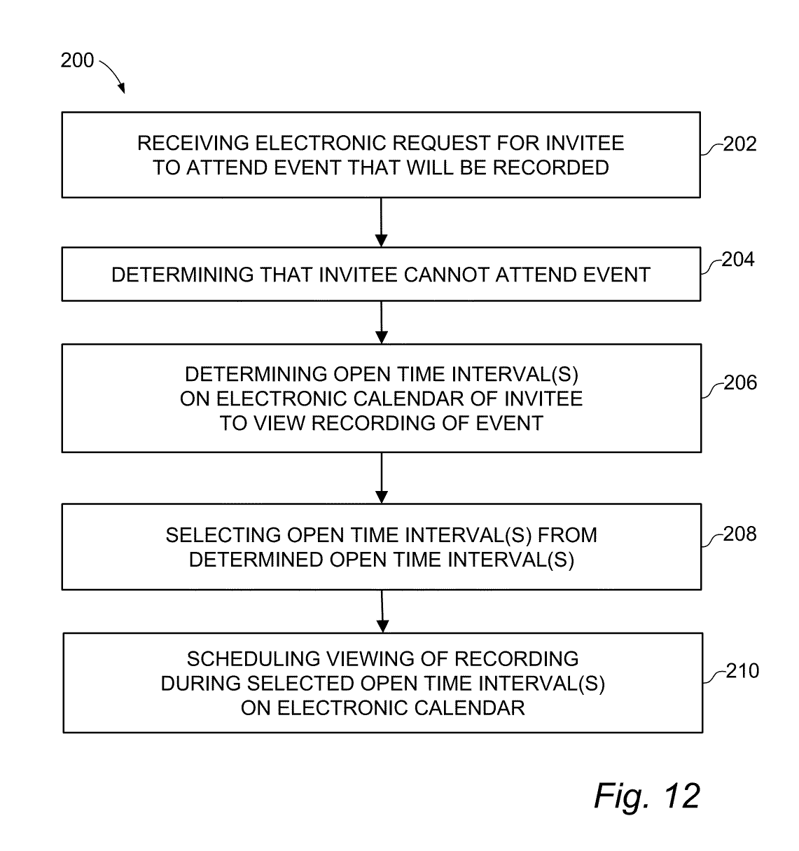

Referring now also to FIG. 12, a method 200 for scheduling viewing of recorded events 98 may include receiving, such as by an electronic apparatus, an electronic request for an invitee to attend an event that will be recorded, at 202. The method may additionally include determining, such as by an electronic apparatus, that the invitee cannot attend the event, at 204. The method may further include determining, such as by an electronic apparatus, one or more open time intervals on an electronic calendar of the invitee to view a recording of the event, at 206. The method may additionally include selecting, such as by an electronic apparatus, at least one open time interval from the determined one or more open time intervals, at 208. The method may further include scheduling, such as by an electronic apparatus, viewing of the recording during the selected open time interval on the electronic calendar, at 210. Method 200 may include other, alternative, or additional elements; may omit one or more elements; and/or may follow a different sequence of elements from that listed.

Receiving an electronic request for an invitee to attend an event may include maintaining, such as by an electronic apparatus, a connection to a network; monitoring the connection to detect incoming messages; processing incoming messages to detect one or more requests among the messages; processing one or more detected requests (e.g., to extract scheduling parameters for the associated event); and/or alerting the user and/or invitee to the detected requests. For example, request 74 may be transmitted as an email invitation message, and calendar 78 may be a portion of an email program. The email program may at intervals query an email server on network 66 to obtain email messages stored for or relayed to an associated email account. On receipt of one or more new email messages, the email program may identify one or more messages as requests 74 and pass on the requests to calendar 78.

Determining that the invitee cannot attend the event may include extracting one or more scheduling parameters that identify an event from a received request; performing time-span analysis to identify one or more time intervals concurrent with the event; and/or performing appointment-conflict analysis on the concurrent time intervals to detect at least one preexisting appointment that occurs during the planned event. In an embodiment, determining that at least one conflict exists between the calendar (or the concurrent time intervals of the calendar 78) and the event (or the time period defined by the scheduling parameters) constitutes a determination that the invitee cannot attend. In an embodiment, receiving input from a user that the invitee cannot attend constitutes a determination that the invitee cannot attend. The user and invitee may be the same person or different persons. (e.g., when the user of an electronic apparatus receives email messages forwarded by the invitee, for example, to delegate scheduling tasks).

If it is determined that the invitee potentially can attend the event, then the user may be prompted for a decision to accept or refuse an appointment for the event. On acceptance, another request may be considered. On refusal, the refusal may be treated as an input that the invitee cannot attend.

Determining open time interval(s) on a calendar of an invitee to view a recording of an event may include extracting one or more scheduling parameters from the request; obtaining or calculating the duration of the event, identifying the first-later time interval of calendar; performing time-span analysis starting with the first-later time interval to identify a block of one or more later time intervals that, taken together, have a duration greater than or equal to the event duration (a candidate interval); and/or performing appointment-conflict analysis on the candidate interval to identify at least one conflicting, pre-existing appointment. If no conflict is identified, then the candidate interval may be added to a list of open time intervals, and/or the previous processing may be repeated for one or more subsequent later time intervals, such as to add further open intervals to the list. The determination of open time intervals may stop after reaching stopping criteria, such as a specified maximum number of intervals on the list or a specified maximum date for scheduling. If at least one conflicting appointment exists for a candidate interval, then the candidate interval may be discarded and/or a next-later time interval may be identified.

Selecting at least one open time interval from the determined open time interval(s) may include prompting the user or invitee to accept or refuse an appointment for the event during the open interval, such as by selecting an open interval from the list of open intervals. On acceptance, the selected open interval may be identified for scheduling. On refusal, the event may be marked as refused and the method may return to generating a list of additional open intervals. For a refused event, data generated for the event may be stored, such as the list of open time intervals, to allow the user or invitee to accept the event after reconsideration.

Scheduling viewing of the recording during the selected open time interval on the calendar may include entering the event as a new appointment associated with the selected time interval; changing one or more values in registry 130 to indicate that the associated time interval is an occupied interval; recording, storing, or registering data describing the event and associating the stored data with the selected time interval; and/or entering appointment data in a reminder system, if available. Electronic apparatus 76 or calendar 78 may further include user-interface features for managing scheduled events, such as for deleting accepted events from the calendar and/or for moving accepted events from one open interval to a different open interval on the list.

In an embodiment, method 200 may further comprise determining a predicted length (or duration) of the recording before the recording is made, based on one or more scheduling parameters of the event. For example, if request 74 is transmitted before the associated event occurs—that is, because the request is an invitation to a future event—then event start time 114 and event end time 115 parameters may represent predicted, expected, and/or planned values. Method 200 may thus include determining, by an electronic apparatus, one or more open time intervals on the calendar to view the recording based, at least in part, on the predicted length of the recording.

In an embodiment, method 200 may further include determining an actual length (or duration) of the recording after the recording is made. For example, apparatus 76 may send data request 108 to server 96 that stores the recorded event to query the server for actual start time 152 and actual end time 154 (and/or actual length 156). The server may return data reply 109 containing the requested actual times, which may allow calculation of actual length 156 (if necessary). After obtaining or calculating the actual length, the actual length 156 may be compared with the predicted length 146; one or more open time intervals to view the recording may be re-determined (if length 156 differs from length 146) based, at least in part, on the actual length; and/or at least one open time interval may be reselected (such as if the re-determined time interval differs from an originally determined interval) based on the re-selected interval.

For example, this re-determination and re-selection may occur as an automatic feature of calendar 78. This feature may include recording at least predicted end time 115 of the scheduled event; waiting until after end time 115; sending data request 108 to recording server 96, such as to query the server for the presence of corresponding recorded event 98; and, when event 98 is present, determining actual length 156, comparing it to predicted length 146, etc. An effect of this re-determination and re-selection may be to confirm, after the publication of the recorded event and based on its actual length 156, that the time interval(s) selected based on predicted length 146 is still appropriate—and, if not, to identify one or more new time intervals based on different actual length 156. For example, if actual length 156 is greater than predicted length 146, such as because the event ran long, then an originally suggested time interval(s) may be too brief to display actual recorded event 98.

In an embodiment, method 200 may further comprise distributing viewing of a recording into two or more viewing sessions and determining one or more open time intervals for at least one session of the two or more sessions. Distributing the viewing of a recording may include obtaining or calculating length 146 or 156 of recorded event 98, applying one or more dividing criteria, and dividing the recorded event 98 into two or more segments 160 according to applicable criteria. For example, if the recording is a one-hour video and the dividing criterion is a parameter set by invitee 82 to limit maximum viewing session length to 15 minutes, then apparatus 76 may divide the event into a series of four 15-minute segments. Determining one or more open time intervals may include preserving the sequence of segments 160 of the recorded event in the sequence of one or more selected viewing sessions 162 (or time intervals 120) and obtaining, generating, and/or recording context data associated with each event segment 160 and/or time interval 120 (or session 162). An example of context data is a link to an internal address within the recorded event 98 so that a second or subsequent session can resume playback where the previous session left off.

Continuing the example, apparatus 76 may determine one or more first time intervals 120 (or viewing sessions 162) for the first 15-minute event session, one or more second time intervals 120 or 162 for the second 15-minute session, and so on. During selecting open time intervals at 208, the user or invitee may specify or select a particular first time interval for the first event segment, in effect entering a specific appointment for the first event segment. Selecting open time intervals at 208 may include disregarding any second time intervals that precede the end time of the first selected time interval and selecting a second time interval from the remaining (or later) second time intervals, such as in order to display the event segments in the right order. Because the invitee may have no time or interest in viewing subsequent event segments, the method may include features for disregarding one or more event segments such that the invitee may view only specified portions of the recorded event. For example, the user may view the first segment and ignore the remaining segments. The process may repeat to select a time interval for each subsequent event segment until done, while progressively excluding preceding inapplicable intervals to protect the viewing sequence. The result may be a division of the recorded event into a series of segments viewed in a series of sessions, each with a corresponding selected time interval, the segments being arranged to view the segments in order.

In an embodiment, method 200 may further comprise selecting, for a recording that will be available for viewing only for a specific time interval, at least one open time interval from the determined one or more open time intervals on the electronic calendar to view the recording within the specific time interval. The above selecting may include obtaining availability date 170 and/or expiration date 172 for recorded event 98 (e.g., by sending a data request 108 to the associated recording server 96) and limiting one or more steps of method 200 to time intervals that are on or after the availability date and that are before or on the expiration date. Additionally, the above selecting may provide information to the user or invitee regarding the expiration date, such a “limited time” warning associated with the determined time intervals, so that the user or invitee knows that the recorded event 98 may become unavailable after the expiration date.

Method 200 may further include selecting at least one open time interval from the determined open time interval(s), presenting an invitee or user with one or more of the determined open time interval(s), and receiving a selection from the invitee or user for the selected open time interval. The above selecting may include preparing a list of one or more open (or uncommitted) time intervals 126 during which the invitee may potentially view recorded event 98; presenting the list to the invitee or user via a user-interface feature, such as a check-box selection mechanism; waiting for the user to choose an item from the list; receiving the selection (user input) when provided, such as by identifying and recording the user-selected option; and/or entering an appointment corresponding to the selection.

Apparatus 76 may receive preference and/or selection data from user-interface components appropriate to its operation, such to allow the invitee or user to define preference values, such as a maximum session length, to allow the invitee or user to select time intervals for appointments to view recorded events, etc.

In an embodiment, method 200 may further comprise providing a link in calendar for the invitee to view the remainder of the recording. A link may be include a hyperlink expressed in HTML or other markup language, having an anchor portion (the visible text or graphic that, when clicked, opens the link) and a hypertext reference portion (the coded URL of the target of the link, such as a link to recorded event or to the start of an internal segment of a recorded event). The effect of the link may be to allow the user or invitee a convenient means of starting the display of an event or segment of an event from calendar 78.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving, by an electronic apparatus, an electronic request for an invitee to attend an event that will be recorded;
determining, by the electronic apparatus, that the invitee cannot attend the event;
determining, by the electronic apparatus, one or more open time intervals on an electronic calendar of the invitee to view a recording of the event;
selecting, by the electronic apparatus, at least one open time interval from the determined one or more open time intervals; and
scheduling, by the electronic apparatus, viewing of the recording during the selected open time interval on the electronic calendar.

2. The method of claim 1, where the event includes one or more scheduling parameters, wherein determining, by the electronic apparatus, that the invitee cannot attend the event includes determining, by the electronic apparatus, that at least one conflict exists in the electronic calendar with the one or more scheduling parameters.

3. The method of claim 1, wherein determining, by the electronic apparatus, that the invitee cannot attend the event includes receiving, by the electronic apparatus, input from a user that the invitee cannot attend the event.

4. The method of claim 1, further comprising determining, by the electronic apparatus, a predicted length of the recording before the recording is made based on one or more scheduling parameters of the event, wherein determining, by the electronic apparatus, one or more open time intervals on an electronic calendar of the invitee to view a recording of the event includes determining, by the electronic apparatus, one or more open time intervals on the electronic calendar to view the recording based, at least in part, on the predicted length of the recording.

5. The method of claim 4, further comprising:
determining, by the electronic apparatus, an actual length of the recording after the recording is made;
comparing, by the electronic apparatus, the actual length with the predicted length;
redetermining, by the electronic apparatus, one or more open time intervals on the electronic calendar to view the recording based, at least in part, on the actual length when the actual length is different from the predicted length;
reselecting, by the electronic apparatus, at least one open time interval from the redetermined one or more open time intervals; and
rescheduling, by the electronic apparatus, viewing of the recording during the reselected open time interval on the electronic calendar when the reselected open time interval is different from the selected open time interval.

6. The method of claim 1, wherein determining, by the electronic apparatus, one or more open time intervals on an electronic calendar of the invitee to view a recording of the event includes distributing, by the electronic apparatus, viewing of the recording into two or more sessions and determining, by the electronic apparatus, one or more open time intervals on the electronic calendar for at least one session of the two or more sessions.

7. The method of claim 1, where the recording will be available for viewing only for a specific time interval, wherein selecting, by the electronic apparatus, at least one open time interval from the determined one or more open time intervals includes selecting, by the electronic apparatus, at least one open time interval on the electronic calendar to view the recording within the specific time interval.

8. The method of claim 1, wherein selecting, by the electronic apparatus, at least one open time interval from the determined one or more open time intervals includes:
presenting, by the electronic apparatus, a user with the determined one or more open time intervals; and
receiving, by the electronic apparatus, a selection from the user for the selected open time interval.

9. The method of claim 1, further comprising:
detecting, by the electronic apparatus, that the invitee has viewed less than all of the recording;
determining, by the electronic apparatus, one or more open time intervals on the electronic calendar to view a remainder of the recording;
selecting, by the electronic apparatus, at least one open time interval from the determined one or more open time intervals for viewing the remainder of the recording; and
scheduling, by the electronic apparatus and on the electronic calendar, viewing of the remainder of the recording during the selected open time interval for viewing the remainder of the recording.

10. The method of claim 9, further comprising providing, by the electronic apparatus, a link in the electronic calendar for the invitee to view the remainder of the recording.

11. A computer system, comprising:
a processor;
a memory; and
a program comprising a plurality of instructions stored in the memory that are executed by the processor to:
receive an electronic request for an invitee to attend an event that will be recorded;
determine that the invitee cannot attend the event;
determine one or more open time intervals on an electronic calendar of the invitee to view a recording of the event;
select at least one open time interval from the determined one or more open time intervals; and
schedule viewing of the recording during the selected open time interval on the electronic calendar.

12. The computer system of claim 11, wherein the plurality of instructions further comprises instructions that are executed by the processor to determine that at least one conflict exists in the electronic calendar with one or more scheduling parameters of the event.

13. The computer system of claim 11, wherein the plurality of instructions further comprises instructions that are executed by the processor to:
determine a predicted length of the recording before the recording is made based on one or more scheduling parameters of the event; and
determine one or more open time intervals on the electronic calendar to view the recording based, at least in part, on the predicted length of the recording.

14. The computer system of claim 13, wherein the plurality of instructions further comprises instructions that are executed by the processor to:
determine an actual length of the recording after the recording is made;
redetermine one or more open time intervals on the electronic calendar to view the recording based, at least in part, on the actual length when the actual length is different from the predicted length;
reselect at least one open time interval from the redetermined one or more open time intervals; and
reschedule viewing of the recording during the reselected open time interval on the electronic calendar when the reselected open time interval is different from the selected open time interval.

15. The computer system of claim 11, wherein the plurality of instructions further comprises instructions that are executed by the processor to:
distribute viewing of the recording into two or more sessions; and
determine one or more open time intervals on the electronic calendar for at least one session of the two or more sessions.

16. A computer program product for scheduling viewing of a recorded event, the computer program product comprising:
at least one computer readable storage medium having computer readable program instructions embodied therewith, the computer readable program instructions, when read by a processor, being configured to:
receive an electronic request for an invitee to attend an event that will be recorded;
determine that the invitee cannot attend the event;
determine one or more open time intervals on an electronic calendar of the invitee to view a recording of the event;
select at least one open time interval from the determined one or more open time intervals; and
schedule viewing of the recording during the selected open time interval on the electronic calendar.

17. The computer program product of claim 15, wherein the computer readable program instructions, when read by a processor, are further configured to:
determine a predicted length of the recording before the recording is made based on one or more scheduling parameters of the event; and
determine one or more open time intervals on the electronic calendar to view the recording based, at least in part, on the predicted length of the recording.

18. The computer program product of claim 17, wherein the computer readable program instructions, when read by a processor, are further configured to:
determine an actual length of the recording after the recording is made;
redetermine one or more open time intervals on the electronic calendar to view the recording based, at least in part, on the actual length when the actual length is different from the predicted length;
reselect at least one open time interval from the redetermined one or more open time intervals; and
reschedule viewing of the recording during the reselected open time interval on the electronic calendar when the reselected open time interval is different from the selected open time interval.

19. The computer program product of claim 15, wherein the computer readable program instructions, when read by a processor, are further configured to:
distribute viewing of the recording into two or more sessions; and
determine one or more open time intervals on the electronic calendar for at least one session of the two or more sessions.

20. The computer program product of claim 15, wherein the computer readable program instructions, when read by a processor, are further configured to select at least one open time interval on the electronic calendar to view a recording of the event within a specific time interval, the recording being available for viewing only for the specific time interval.
